(19) United States
(12) Patent Application Publication
(10) Pub. No.: US 2025/0224493 A1
(43) Pub. Date: Jul. 10, 2025

(54) ARRANGEMENT FOR DEPTH SENSING, DEVICE, METHODS AND COMPUTER PROGRAM

(71) Applicant: Sony Group Corporation, Tokyo (JP)

(72) Inventors: Dario BRESCIANINI, Stuttgart (DE); Peter DÜRR, Stuttgart (DE)

(73) Assignee: Sony Group Corporation, Tokyo (JP)

(21) Appl. No.: 18/848,934

(22) PCT Filed: Mar. 17, 2023
(86) PCT No.: PCT/EP2023/056942

§ 371 Date: Sep. 20, 2024

(30) Foreign Application Priority Data
Mar. 29, 2022 (EP) 22164905.6

(51) Int. Cl. G01S 7/481; G01S 7/48; G01S 17/42; G01S 17/86; G01S 17/89

(52) U.S. Cl. CPC G01S 7/4816; G01S 7/4802; G01S 7/4815; G01S 7/4817; G01S 17/42; G01S 17/86; G01S 17/89

(57) ABSTRACT

An arrangement for depth sensing is provided. The arrangement for depth sensing comprises a first dynamic vision sensor and a second dynamic vision sensor. Further, the arrangement comprises a beam splitter arranged in an optical path between a scene and the first dynamic vision sensor and the second dynamic vision sensor. The second dynamic vision sensor is calibrated with respect to the first dynamic vision sensor, such that a first field of view observed through the first dynamic vision sensor is substantially identical to a second field of view observed through the second dynamic vision sensor.

### FIELD

Examples relate to an arrangement for depth sensing, a device, methods and a computer program.

### BACKGROUND

There exists a multitude of depth sensing technologies such as laser scanner or light imaging, detection and ranging systems, time-of-flight (ToF) cameras or structured light cameras.

Laser scanners obtain a depth map of the scene by emitting a laser light beam and a sensor to detect the light reflected by objects in the scene in direction of the emitted laser light. By measuring the time in between emitting the light and detecting its reflection, the depth of the scene can be computed using the constant speed of flight. In order to obtain a dense depth map of the scene a sequence of measurements with the laser pointing in different directions has to be taken, which results in low update rates of the entire map, typically in the order of 5-20 Hz.

ToF cameras illuminate a complete scene at once and capture the light being reflected by objects in the scene using a ToF sensor. ToF sensors measure the time interval between emitting light and detecting its reflection for each pixel individually. ToF cameras can therefore obtain a dense depth map in a single shot and achieve frame rates of 20-60 Hz. However, since the light emitted from the ToF camera is spread across the entire field of view, unlike Laser scanners that only illuminate a single point, the signal-to-noise ratio (SNR) is low, which limits the usage of ToF cameras mainly to indoor applications with object distances of 10 m and below.

Structured light cameras sense the depth by projecting a known light pattern onto the scene and observing with a camera where the light pattern is reflected off the scene and how the light pattern is deformed by the scene. By calibrating the light projector and the camera with respect to one another, the observations of the structured light camera can be triangulated, and a single three-dimensional (3D) point can be recovered for each observed illuminated pixel. In order to increase the SNR, only part of the scene can be illuminated, and the light pattern can be moved dynamically across the scene to obtain a dense depth map. However, there is a tradeoff, since the smaller the light pattern and the higher the SNR, the more measurements need to be taken to obtain a complete depth scan of the scene. The speed of structured light cameras is thus limited by the speed of the projector and the camera, and an update rate of 30-60 Hz can be typically achieved.

Thus, there may be a need to improve a depth sensing technology.

### SUMMARY

This demand is met by arrangements for depth sensing, devices and methods in accordance with the independent claims. Advantageous embodiments are addressed by the dependent claims.

According to a first aspect, the present disclosure provides an arrangement for depth sensing, comprising a first dynamic vision sensor and a second dynamic vision sensor. Further, the arrangement comprises a beam splitter arranged in an optical path between a scene and the first dynamic vision sensor and the second dynamic vision sensor. The second dynamic vision sensor is calibrated with respect to the first dynamic vision sensor, such that a first field of view observed through the first dynamic vision sensor is substantially identical to a second field of view observed through the second dynamic vision sensor.

According to a second aspect, the present disclosure provides a device, comprising a light source to emit light onto a scene comprising a first wavelength and a dynamic vision sensor comprising a plurality of light filters. A first light filter of the plurality of light filters transmits the first wavelength and a second light filter of the plurality of light filters transmits a second wavelength different from the first wavelength. Further, the device comprises processing circuitry communicatively coupled to the dynamic vision sensor and configured to determine a depth information of the scene based on information received from the dynamical vision sensor based on the first wavelength and update the depth information of the scene based on the information received from the dynamical vision sensor based on the second wavelength.

According to a third aspect, the present disclosure provides a method, comprising detecting reflected light from a scene with a first dynamic vision sensor and detecting reflected light from the scene with a second dynamic vision sensor. A first field of view observed through the first dynamic vision sensor is substantially identical to a second field of view observed through the second dynamic vision sensor.

According to a fourth aspect, the present disclosure provides a method, comprising detecting reflected light of a first wavelength from a scene with a dynamic vision sensor and detecting reflected light of a second wavelength from a scene with the dynamic vision sensor. Further, the method comprises determining a depth information of the scene based on information received from the dynamical vision sensor based on the first wavelength from the dynamic vision sensor and updating the depth information of the scene based on the information received from the dynamical vision sensor based on the second wavelength from the dynamic vision sensor.

According to a fifth aspect, the present disclosure provides a computer program having a program code for performing the method as described above, when the computer program is executed on a computer, a processor, or a programmable hardware component.

### BRIEF DESCRIPTION OF THE FIGURES

Some examples of apparatuses and/or methods will be described in the following by way of example only, and with reference to the accompanying figures, in which

FIG. 1 shows an example of an arrangement for depth sensing;

FIG. 2 shows another example of an arrangement for depth sensing;

FIG. 3 shows an example of a device;

FIG. 4 shows another example of a device;

FIG. 5 shows two different examples of devices for depth sensing;

FIG. 6 shows examples of different DVS;

FIG. 7 shows a block diagram of an example of a method for depth sensing; and

FIG. 8 shows a block diagram of another example of a method for depth sensing.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, e.g. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

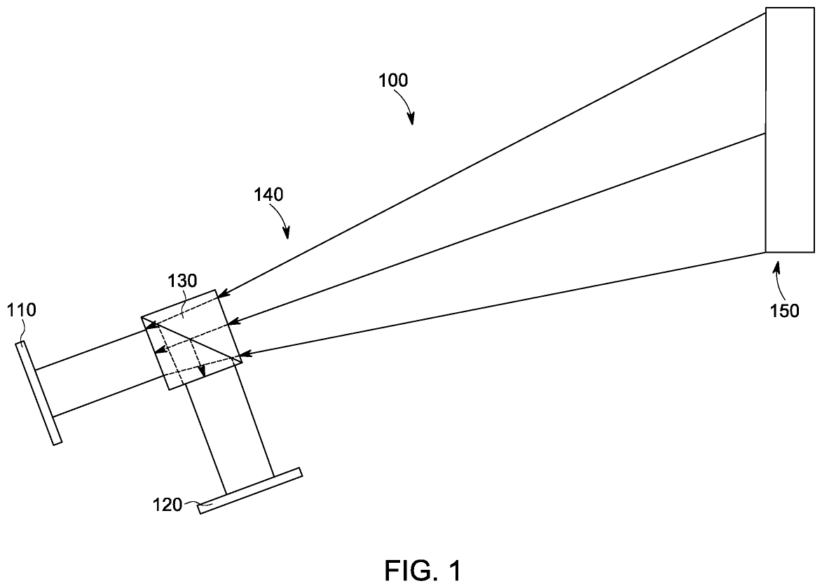

FIG. 1 shows an example of an arrangement 100 for depth sensing. The arrangement 100 for depth sensing, comprises a first dynamic vision sensor 110 (DVS) and a second dynamic vision sensor 120. Further, the arrangement 100 comprises a beam splitter 130 arranged in an optical path 140 between a scene 150 and the first dynamic vision sensor 110 and the second dynamic vision sensor 120. The second dynamic vision sensor 120 is calibrated with respect to the first dynamic vision sensor 110, such that a first field of view observed through the first dynamic vision sensor 110 is substantially identical to a second field of view observed through the second dynamic vision sensor 120. By combining two DVS 110, 120, the first DVS 110 and the second DVS 120, which comprise a substantially identical field of view, an information depth received from the scene 150 can be increased.

For example, the first DVS 110 can be used to determine a first event and the second DVS 120 can be used to determine a second event. Thus, by combining the two DVS 110, 120 by use of a beam splitter 130, a temporal resolution of a DVS 110, 120 (e.g., of the first DVS 110 by using events of the second DVS 120 for updating/calibrating the first DVS 110) and/or a robustness of a depth map provided by any DVS 110, 120 can be increased. For example, the first DVS 110 can be used to determine an event triggered by the light projected onto the scene 150 and the second DVS 120 can be used to determine an event triggered by a moving object or the ego-motion of the arrangement 100. The information determined by the first DVS 110 and the second DVS 120 may be combined to improve the temporal resolution and/or a depth map of either. A combination of the information of the first DVS 110 and the second DVS 120 may be enabled by the substantially identical field of view of both DVS 110, 120. Thus, by use of the beam splitter 130 the arrangement 100 can be improved in an eased way. For example, a setup for the arrangement 100 for depth sensing may be facilitated by use of the beam splitter 130.

Recently, the speed limitations of traditional structured light cameras have been partially overcome using event-based structured light cameras, e.g., where the camera sensor has been replaced with a DVS 110, 120.

A DVS 110, 120 may capture a light intensity (e.g., a brightness, luminous intensity) change of light received from the scene 150 over time. The DVS 110, 120 may include pixels operating independently and asynchronously. The pixels may detect the light intensity change as it occurs. Otherwise the pixels may stay silent. The pixels may generate an electrical signal, e.g., called event, which may indicate per-pixel light intensity a change by a predefined threshold. Accordingly, the DVS 110, 120 may be an example for an event-based image sensor.

Each pixel may include a photo-sensitive element exposed to the light received from the scene 150. The received light may cause a photocurrent in the photo-sensitive element depending on a value of light intensity of the received light. A difference between a resulting output voltage and a previous voltage reset-level may be compared against the predefined threshold. For instance, a circuit of the pixel may include comparators with different bias voltages for an ON-and an OFF-threshold. The comparators may compare an output voltage against the ON-and the OFF-threshold. The ON-and the OFF-threshold may correspond to a voltage level higher or lower given by the predefined threshold than the voltage reset-level, respectively. When the ON-or the OFF-threshold is crossed, an ON-or an OFF-event may be communicated to a periphery of the DVS 110, 120, respectively. Then, the voltage reset-level may be newly set to the output voltage that triggered the event. In this manner, the pixel may log a light-intensity change since a previous event. The periphery of the DVS 110, 120 may include a readout circuit to associate each event with a time stamp and pixel coordinates of the pixel that recorded the event. A series of events captured by the DVS 110, 120 at a certain perspective and over a certain time may be considered as an event stream.

Thus, a DVS 110, 120 may have a much higher bandwidth than a traditional sensor as each pixel responds asynchronously to a light intensity change. A DVS 110, 120 may achieve a temporal resolution of 1 μs. 3D points may be triangulated at the same temporal resolution of 1 μs. Thus, a resulting complete depth scans at rates larger than 1 kHz can be achieved.

However, events may not only be triggered by the structured light projected onto the scene 150, but also due to objects moving in the scene 150 or an ego-motion of a sensing device, e.g., the arrangement 100, which may comprise the first DVS 110 and the second DVS 120. In order to solve a correspondence problem robustly, e.g., assigning an event to a laser direction for computing its depth, multiple measurements may need to be taken, decreasing the theoretically achievable update rate. By combining the first DVS 110 and the second DVS 120 using a substantially identical field of view the update rate can be increased, since the information depth of the scene 150 can be increased. For example, as described above one DVS 110, 120, e.g., the first DVS 110, may be assigned to determine an event triggered by the light projected onto the scene 150 and another DVS 110, 120, e.g., the second DVS 120 may be assigned to determine an event triggered by a moving object or an ego-motion of the arrangement 100 for depth sensing. Thus, the information determined by the second DVS 120 can be used to trigger an update of the first DVS 110. This, way an event-based depth map at the temporal resolution of the first DVS 110 (since the second DVS can be used to determine updates) and/or an increase of the robustness of the depth map provided by the first DVS 110 can be achieved.

Thus, the arrangement 100 for depth scanning can produce high-speed 3D scans with microseconds resolution and/or can perform event-based updates of the depth map. By using a beam splitter 130 events due to motion (e.g., a moving object, an ego-motion of the arrangement 100) can be filtered out by use of two DVS 110, 120, e.g., using the second DVS 120, with a substantially same field of view for determining events due to motion as update trigger. The information determined by the second DVS 120 can be used to update the depth map provided by the first DVS 110 in between depth scans (e.g., triggered by events caused by a light projected onto the scene 150) of the first DVS 110.

In an example, the first dynamic vision sensor 110 may be configured to detect a change in luminance in a photo-current of the scene 150 at a first wavelength and the second dynamic vision sensor 120 may be configured to detect a change in luminance in a photo-current of the scene 150 at a second wavelength different from the first wavelength. Thus, a determination of information corresponding to the first DVS 110, or the second DVS 120 can be eased. For example, by using a first wavelength for determining an event triggered by a light projected onto the scene 150, a determination by the first DVS 110 can be improved, since a light intensity change at another wavelength can be neglected (leading to no change in luminance in the photo-current of the first DVS 110).

Optionally, the first DVS 110 and/or the second DVS 120 may be configured to detect the change in luminance in the photo-current of the scene 150 at a range of wavelength comprising the first wavelength or the second wavelength, respectively. Thus, a determination of an event can be improved. The range of wavelength may comprise contiguous or non-contiguous wavelengths.

In an example, the arrangement 100 may further comprise a first lens corresponding to the first dynamic vision sensor 110 and a second lens corresponding to the second dynamic vision sensor 120. The beam splitter 130 may be arranged in an optical path between the scene 150 and the first lens and the second lens. The first lens and the second lens can be used to calibrate the first field of view or the second field of view, respectively. Thus, a calibration of both field of views can be eased. For example, the first field of view and the second field view can be determined by a characteristic of the beam splitter 130 and the first lens or the second lens, respectively.

In an example, the beam splitter 130 may substantially transmit 50% of the light along the optical path and may substantially reflect 50% of the light along the optical path. Thus, an intensity of light, which is directed towards the first DVS 110 may be substantially the same as an intensity of light directed towards the second DVS 120. Alternatively, the beam splitter 130 may transmit a different amount of light as it may reflect. This way, an intensity of light at the first DVS 110 and/or the second DVS 120 can be adjusted, e.g., the beam splitter 130 may transmit a smaller amount of the first wavelength, if the first wavelength is generated by a light source.

In an example, the arrangement 100 may further comprise a light source to emit light onto the scene 150 comprising the first wavelength. Thus, an event, which can be detected by the first DVS 110 or the second DVS 120, can be controlled/triggered by the light source. Further, a light intensity at the first DVS 110 or the second DVS 120 can be controlled by the light source, which may increase a SNR.

In an example, the arrangement 100 may further comprise an optical diffraction grating to generate a light pattern that is cast onto the scene 150 and reflected by the scene 150 towards the beam splitter 130. Thus, by using the optical diffraction grating an illumination of the scene 150 can be adjusted.

In an example, the arrangement 100 may further comprise a scanning mirror that can be used to change an illuminance of the light pattern onto the scene 150. This way, the illuminance of the light pattern can be controlled by the scanning mirror, e.g., by an orientation of the scanning mirror, such that a correlation between the illuminance of the light pattern and an event determined by the first DVS 110 (or the second DVS 120) can be determined. For example, an event determined by the first DVS 110 (or the second DVS 120) may be assigned to a specific orientation of the scanning mirror. Thus, the scanning mirror can be used to trigger events at the first DVS 110 (or the second DVS 120). Further, the scanning mirror can be used to direct the light pattern towards an object-of-interest or a region-of-interest in the scene 150. This way, a determination of the object-of-interest or the region-of-interest can be increased.

In an example, the arrangement 100 may further comprise processing circuitry communicatively coupled to the scanning mirror, the first dynamic vision sensor 110 and the second dynamic vision sensor 120. Further, the processing circuitry may be configured to control an orientation of the scanning mirror and to receive information from the first dynamic vision sensor 110 and the second dynamic vision sensor 120. This way, the processing circuitry can determine a correlation between an orientation of the scanning mirror and the first DVS 110 or the second DVS 120.

In an example, the processing circuitry may be further configured to read events of at least one of the first dynamic vision sensor 110 or the second dynamic vision sensor 120 for time synchronization between an orientation of the scanning mirror and at least one of the first dynamic vision sensor 110 or the second dynamic vision sensor 120. This way, the processing circuitry can perform a desired operation/calculation. For example, for each event triggered at the first DVS 110, which correlates with an assigned orientation or movement of the scanning mirror, a depth map can be calculated by the processing circuitry based on an event read from the first DVS 110.

In an example, the processing circuitry may be further configured to determine a depth information, e.g., a depth map, of the scene 150 based on information received from the first dynamic vision sensor 110. Optionally, information about the orientation of the scanning mirror may be additionally used by the processing circuitry to determine the depth information.

In an example, the processing circuitry may be further configured to update the depth information of the scene 150 based on information received from the second dynamic vision sensor 120. This way, the second DVS 120 can be utilized to provide a trigger for an update. For example, the trigger for the update may be provided by an event triggered by a moving object or an ego-motion of the arrangement 100 determined at the second DVS 120. Thus, the determination of the depth map may be improved by considering an update event, which could distort or influence a generation of the depth map. The update event may be triggered by a movement in the scene and/or a movement of the arrangement 100.

In an example, the arrangement 100 may further comprise an inertial measurement unit (IMU) communicatively coupled to the processing circuitry. The IMU may be configured to determine at least one of information about a movement of the scene 150 (comprising information a movement of a moving object in the scene) or information about a movement of the arrangement 100 and to detect a dynamic object in the scene 150 based on the determined information about at least one of a movement of the scene 150 or a movement of the arrangement 100. Thus, a detection of an event triggered by a moving object, or the egomotion of the arrangement 100 can be detected in an improved way by the IMU. For example, the IMU may comprise an acceleration sensor, e.g., a magnetic field acceleration sensor, capable to detect a movement of the arrangement 100. Also by determining a movement of the arrangement 100 the IMU may be capable to determine a movement of a moving object in the scene 150, e.g., by a difference calculation of movement speeds of the arrangement 100 and the moving object in the scene 150.

In an example, the arrangement 100 may further comprise a further light source to emit light onto the scene 150. Thus, an event, which can be detected by the first DVS 110 or the second DVS 120, can be controlled/triggered by the further light source. Thus, an illuminance of the scene 150 can be increased, which may increase a light intensity at the first DVS 110 and/or the second DVS 120.

In an example, the light emitted by the further light sources may comprise the first wavelength or the second wavelength. For example, a SNR of the second DVS 120 can be increased by the further light source emitting light comprising the second wavelength.

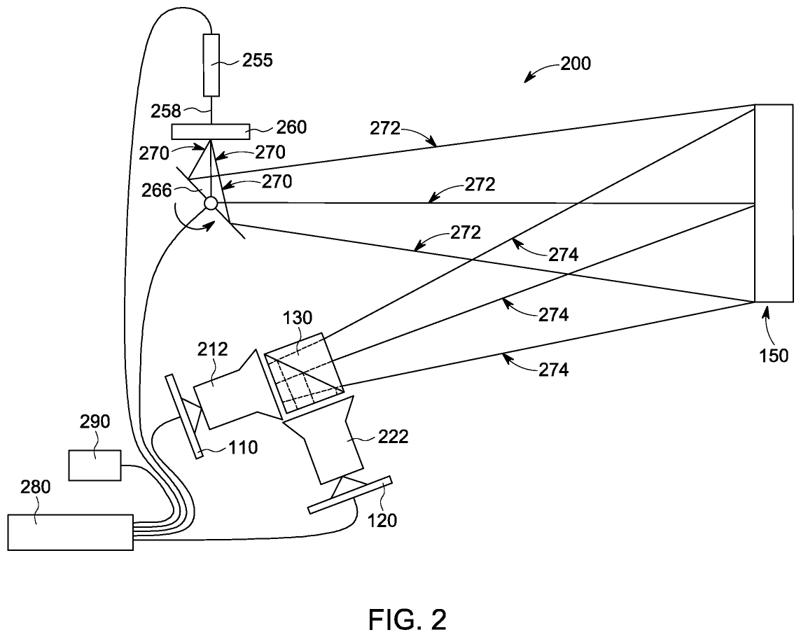

More details and aspects are mentioned in connection with the examples described below. The example shown in FIG. 1 may comprise one or more optional additional features corresponding to one or more aspects mentioned in connection with the proposed concept or one or more examples described below (e.g., FIGS. 2-8).

FIG. 2 shows another example of an arrangement 200 for depth sensing. The arrangement 200 may comprise a light source 255, e.g., a laser 255, which may emit a laser beam 258 with a specific wavelength or in a specific wavelength range, e.g., infrared light. The emitted laser beam 258 may be fanned out by an optical diffraction grating 260 producing one or more laser lines that constitute a laser plane 270. The laser plane 270 may be specularly reflected at a scanning mirror 266, producing a laser plane 272 which may finally illuminate an object-of-interest or region-of-interest in the scene 150. A portion of a diffuse reflection 274 of the laser plane 272 may travel towards a beam splitter 130. The beam splitter 130 may substantially transmit 50% of the light through a first lens 212 onto a first DVS 110 and may substantially reflect 50% of the light through a second lens 222 onto a second DVS 120. The first DVS 110 and the second DVS 120 and the first lens 212 and the second 222 may be calibrated with respect to each other such that scene 150 observed through either system (comprising DVS 110, 120 and corresponding lens 212, 222) is substantially identical.

However, the first DVS 110 may only respond to brightness changes at the wavelength or in the wavelength range of the emitted laser beam 258, e.g., infrared light, whereas the second DVS 120 may only respond to brightness changes at a wavelength or in a wavelength range different from the emitted laser beam 258, e.g., visible light.

A scanning mirror 266 can rotate about a vertical axis, moving the emitted light pattern 272 across the scene 150. By moving the light pattern 272 over the scene 150 the scanning mirror 266 may trigger an event at the first DVS 110. For example, the scanning mirror 266 may be actuated using galvanometer or MEMS actuators which achieve driving frequencies in the range of 110 Hz-10 kHz depending on a size of the scanning mirror 266.

A computing device, e.g., the processing circuitry, 280 may be connected to the first DVS 110 and the second DVS 120 and the scanning mirror 266 for time synchronization. The computing device 280 may read an event of the first DVS 110 and the second DVS 120.

Further, the computing device 280 may control an orientation (e.g., a mirror angle) of the scanning mirror 266. For each triggered event of the first DVS 110, the depth of the illuminated point in scene 150 may be computed, e.g., by triangulating its depth using the event coordinates and known scanning mirror angle of 266.

The computing device 280 may store the (dense) depth map in a memory. For each event or set of events of the second DVS 120, the depth map may be updated, using, e.g., an optical flow. Due to the high temporal resolution of a DVS 110, 120, an optical flow of events can readily be computed, and the depth map of the scene 150 can be updated accordingly. The depth map of the pixels may be further improved exploiting, e.g., traditional geometric constraints, smoothness constraints or learning-based depth priors. Learning-based methods such as deep neural networks may be trained in a supervised fashion, where the previous depth map and all subsequent events are given as input to predict the next depth map, and the newly measured depth map is used as ground truth improve the network predictions. In order to further simplify the update of the depth map in between a complete scan, the computing device 280 may be connected to an IMU 290 that is rigidly attached to the sensing device. IMU 290 may not only be used to facilitate the update of the depth map but can also help in detecting dynamic objects in the scene as these will not trigger events that are consistent with the updated depth map using IMU 290.

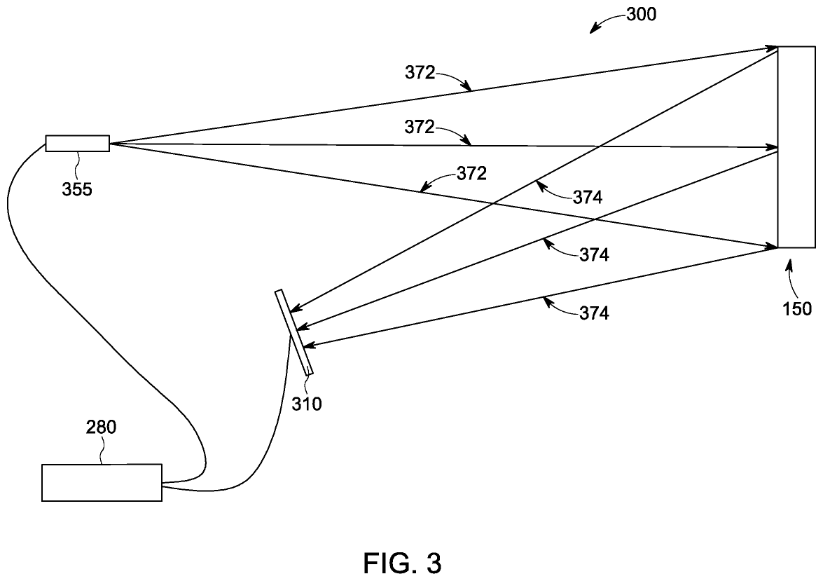

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIGS. 3-8).

FIG. 3 shows an example of a device 300 (for depth sensing). The device 300 comprises a light source 355 to emit light onto a scene 150 comprising a first wavelength and a dynamic vision sensor 310 comprising a plurality of light filters. A first light filter of the plurality of light filters transmits the first wavelength and a second light filter of the plurality of light filters transmits a second wavelength different from the first wavelength. Further, the device 300 comprises processing circuitry 280 communicatively coupled to the dynamic vision sensor 310. The processing circuitry 280 is configured to determine a depth information of the scene 150 based on information received from the dynamical vision sensor 310 based on the first wavelength and update the depth information of the scene 150 based on the information received from the dynamical vision 310 sensor based on the second wavelength. Thus, by use of two different wavelengths and the first light filter and the second light filter an information depth can be increased. This setup may be an alternative to the setup shown with reference to FIG. 1. The advantages described with reference to FIG. 1 can also be achieved by the device 300.

By using a light source 355 and a corresponding light filter at specific wavelength (e.g., the first wavelength and the second wavelength) or specific wavelength ranges (one of the wavelength ranges may comprise the first wavelength and the other the second wavelength), the events due to motion (e.g., a moving object, ego-motion of the device) can be filtered out by a hardware, e.g., a processing circuitry, and can be used to update the depth map, e.g., in between depth scans.

For example, the first wavelength can be used to determine an event triggered by the light projected onto the scene 150 and the second wavelength can be used to determine an event triggered by a moving object or the ego-motion of the device 300. The information determined by the DVS 310 based on the first wavelength and the information of the DVS 310 based on the second wavelength may be combined to improve a temporal resolution and/or a depth map of the scene 150.

In an example, the device 300 may further comprise an optical diffraction grating to generate a light pattern that is cast onto the scene 150 and reflected by the scene 150 towards the DVS 310. Thus, by using the optical diffraction grating an illumination of the scene 150 can be adjusted.

In an example, the device 300 may further comprise a scanning mirror that can be used to change an illuminance of the light pattern onto the scene 150. This way, the illuminance of the light pattern can be controlled by the scanning mirror, e.g., by an orientation of the scanning mirror, such that a correlation between the illuminance of the light pattern and an event determined by the DVS 310 can be determined. For example, an event determined by the DVS 310 may be assigned to a specific orientation of the scanning mirror. Thus, the scanning mirror can be used to trigger events at the DVS 310. Further, the scanning mirror can be used to direct the light pattern towards an object-of-interest or a region-of-interest in the scene 150. This way, a determination of the object-of-interest or the region-of-interest can be increased.

In an example, the processing circuitry 280 may be further communicatively coupled to the scanning mirror. Further, the processing circuitry may be configured to control an orientation of the scanning mirror. This way, the processing circuitry 280 can determine a correlation between an orientation of the scanning mirror and the first DVS 110 or the second DVS 120.

In an example, the processing circuitry 280 may be further configured to read events of the dynamic vision sensor 310 for time synchronization between an orientation of the scanning mirror and the dynamic vision sensor 310. This way, the processing circuitry 280 can perform a desired operation/calculation. For example, for each event triggered at the DVS 310, which correlates with an assigned orientation or movement of the scanning mirror, a depth map of the scene 150 can be calculated by the processing circuitry.

In an example, the processing circuitry 280 may be further configured to determine a depth information, e.g., a depth map, of the scene 150 based on information received from the dynamic vision sensor 310 based on the first wavelength. Optionally, information about the orientation of the scanning mirror may be additionally used by the processing circuitry 280 to determine the depth information.

In an example, the processing circuitry 280 may be further configured to update the depth information of the scene 150 based on information received from the dynamic vision sensor 310 based on the second wavelength. This way, the second wavelength can be utilized to provide a trigger for an update, e.g., of the depth map determined based on the first wavelength. For example, the trigger for the update may be provided by an event triggered by a moving object or an ego-motion of the device 300 determined at the DVS 310. Thus, the determination of the depth map may be improved by considering an update event, which could distort or influence a generation of the depth map based on the first wavelength.

In an example, the device 300 may further comprise an inertial measurement unit (IMU) communicatively coupled to the processing circuitry 280. The IMU may be configured to determine at least one of information about a movement of the scene 150 or information about a movement of the arrangement and to detect a dynamic object in the scene 150 based on the determined information about at least one of a movement of the scene 150 or a movement of the arrangement. Thus, a detection of an event triggered by a moving object, or the ego-motion of the device 300 can be detected in an improved way by the IMU. For example, the IMU may comprise an acceleration sensor capable to detect a movement of the device 300. Also by determining a movement of the device 300 the IMU may be capable to determine a movement of a moving object in the scene 150, e.g., by a difference calculation of movement speeds of the device 300 and the moving object in the scene 150.

In an example, the device 300 may further comprise a further light source to emit light onto the scene 150. Thus, an illuminance of the scene 150 can be increased, which may increase a light intensity at the DVS 310.

In an example, the light emitted by the further light sources may comprise the first wavelength or the second wavelength. For example, a SNR of the DVS 310 based on the second wavelength can be increased by the further light source emitting light comprising the second wavelength.

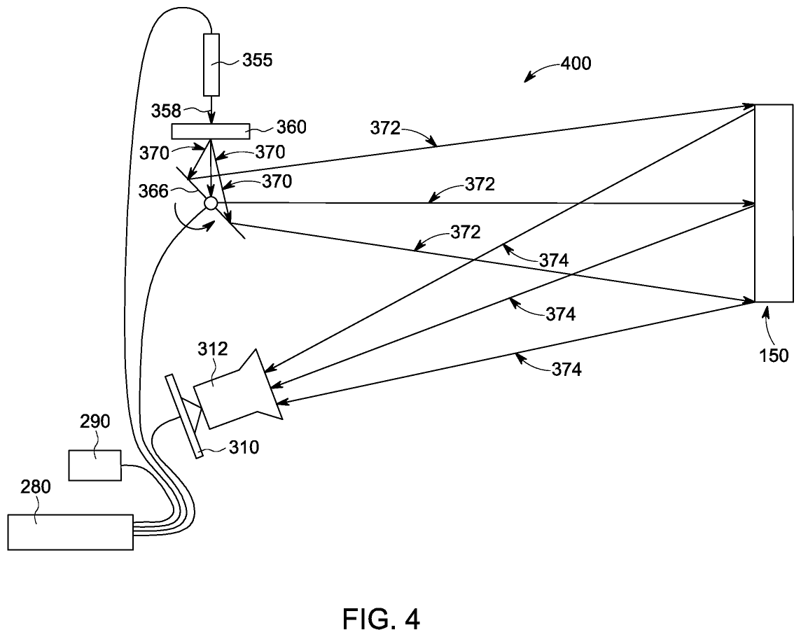

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIGS. 4-8).

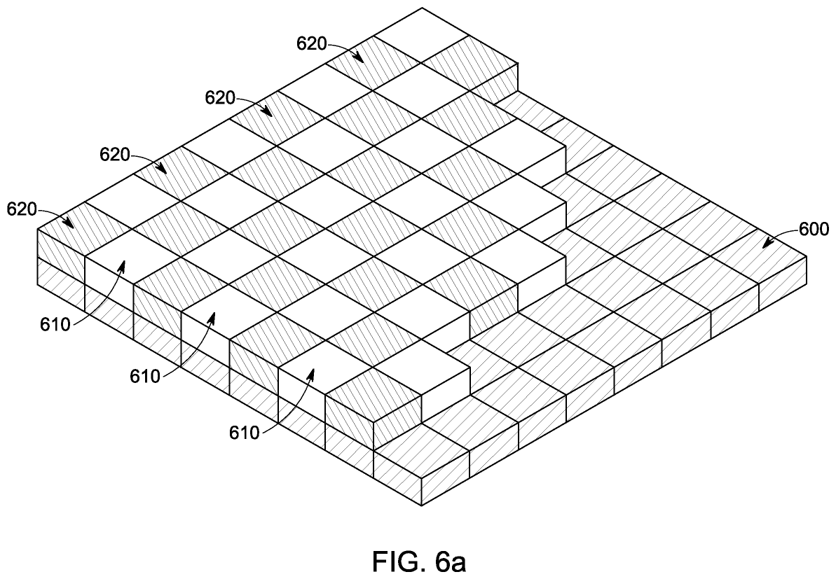

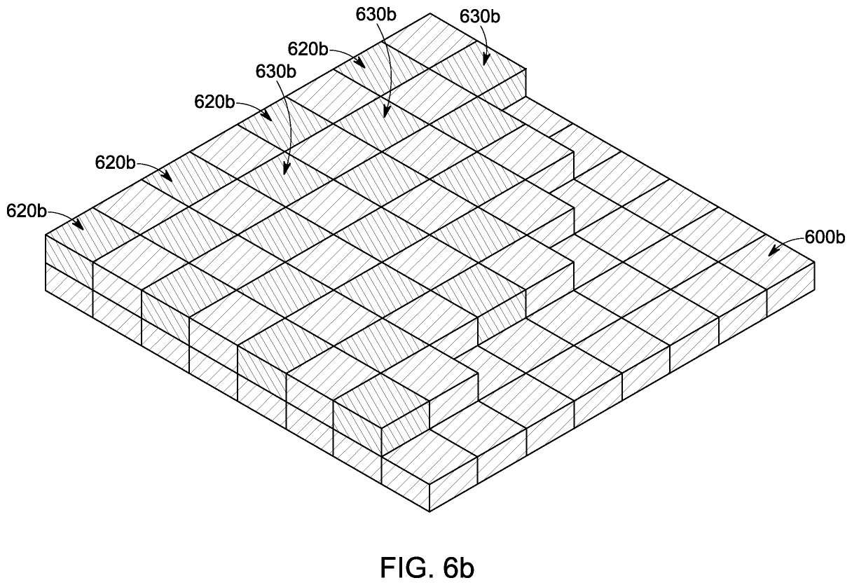

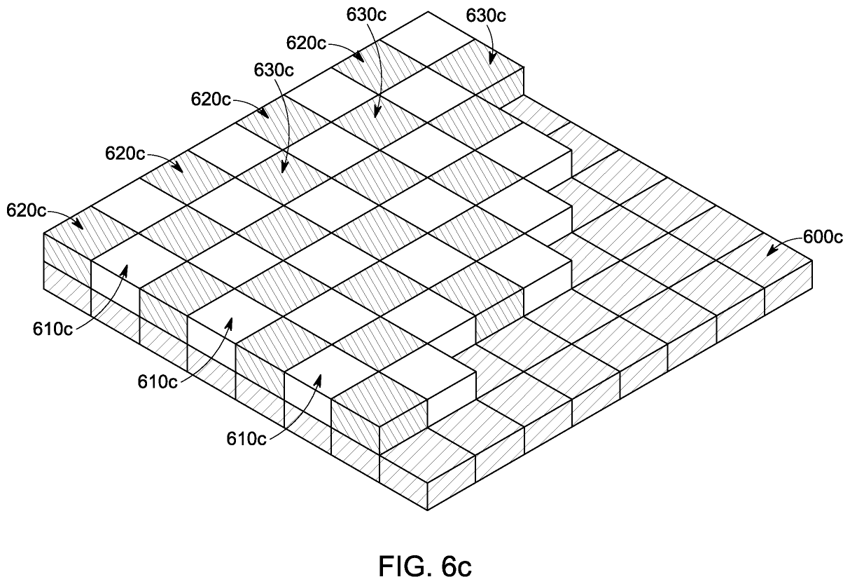

FIG. 4 shows another example of a device 400 (for depth sensing). Instead of using multiple DVS, each responding to brightness changes at a different wavelength or in different wavelength ranges, a single DVS 310 with per-pixel light filter (not shown, see FIG. 6) may be used. In this case, the diffuse reflection 374 travels directly towards lens 312 onto the DVS 310. The DVS 310 is schematically depicted in FIG. 6 (e.g., FIG. 6a). This setup may be an alternative to the setup shown above, especially with reference to FIG. 2.

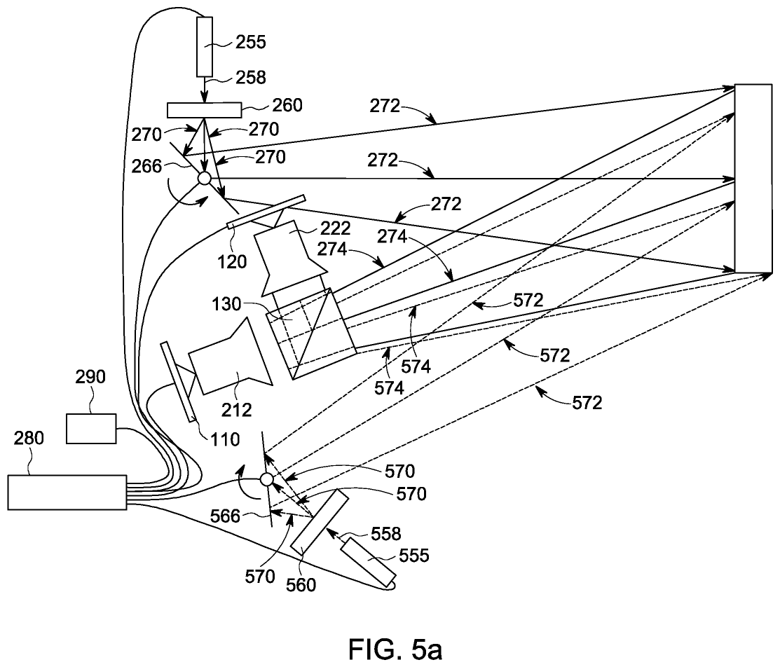

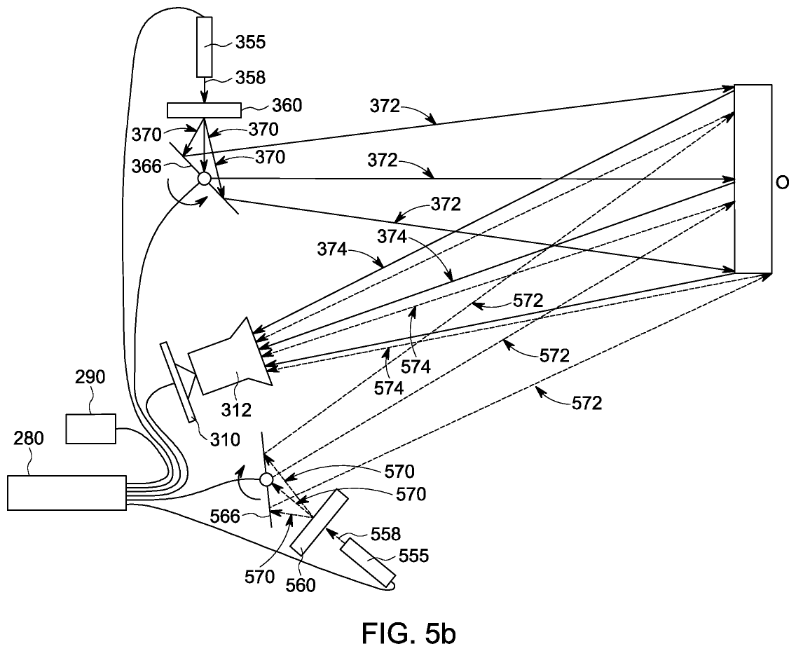

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIGS. 5-8).

FIG. 5 shows two different examples of devices for depth sensing. FIG. 5a shows a device comprising a beam splitter and two DVS 110, 120. FIG. 5b shows a device comprising only a single DVS 310 with a light filter (not shown).

In order to speed up the depth map update rate and/or to minimize an area where depth cannot be computed due to occlusions, multiple light sources 255, 355, 555 illuminating the scene from different viewpoints may be used as shown FIG. 5. The first light source 255, 355 e.g., a first laser, and the second light source 555, e.g., a second laser 555, may emit a first laser beam 258, 358 and a second laser beam 558, respectively. Each laser beam 258, 358, 558 may be emitted with a unique wavelength (or a unique wavelength range), e.g., in the infrared light spectrum, the visible light spectrum, etc. Both emitted laser beams 258, 358 and 558 may be fanned each out by an optical diffraction grating 260, 360, 560, producing one or several laser lines that constitute a first laser plane 270, 370 and a second laser plane 570, respectively. The laser planes 270, 370, 570 may be specularly reflected at their corresponding scanning mirrors 266, 366 and 566. This may produce a first laser planes 272, 372 and a second laser plane 572 which finally illuminate and object or region-of-interest.

A portion of both diffuse reflection 274, 374 and 574 of the laser planes 272, 372, 572 at the scene may travel towards lens onto the first DVS 110 and the second DVS 120 (FIG. 5a) or the single DVS 310 (FIG. 5b). The single DVS 310 is depicted schematically in FIG. 6.

A computing device 280 may generate a (dense) depth map for each DVS 110, 120 (FIG. 5a) or a semi-dense depth map for each laser beam-light filter pair (FIG. 5b). As described below (e.g., with reference to FIG. 6), different geometrical constraints and/or priors may be used to obtain a (dense) depth map from the semi-dense depth map. Furthermore, the events by pixels underneath a first light filter may be used to simplify the computation of a (dense) depth map and to update the (dense) depth map in between complete depth scans.

For example, the light source 255 and the light source 355 may be identical.

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIGS. 1-4) and/or below (e.g., FIGS. 6-8).

FIG. 6 shows examples of different DVS. As can be seen in FIG. 6a on top of the pixels of the sensor array 600 light filters 610, 620 which only transmit light at a specific wavelength or in a specific wavelength range may be arranged. The light filter 610 may only transmit the first wavelength, e.g., visible light, while the filter 620 may only transmit light of the wavelength or the wavelength range of the emitted light 358, e.g., infrared light. The filters 610, 620 may be arranged in different patterns, e.g., a checkerboard pattern.

For each event triggered by a pixel underneath the light filter 620, a computing device, e.g., the processing circuitry as described above, may triangulate a corresponding 3D-information, resulting in a semi-dense depth map after a complete scan of the scene. Using the depth of neighboring pixels, the computing device may compute the depth corresponding to pixels covered by the light filter 610, exploiting, e.g., geometrical constraints, smoothness constraints or learning-based depth priors, yielding a dense depth map. An event triggered by pixels underneath the filter 610 may be used to update a dense depth of the depth map. An optical flow at pixels covered by the filter 620 may be computed using spatial pyramids. Further, the optical flow may be computed by exploring geometric constraints, smoothness constraints or learning-based priors to obtain dense optical flow from coarse to fine. This process may also rely on an output of an IMU that is rigidly attached to the device (see also the IMU described above). Additionally, this process may help to improve the depth estimate at pixels where depth cannot be directly measured.

Instead of that light filter arrangement of FIG. 6a the DVS shown in FIG. 6b may only respond to brightness changes at the wavelength or in a specific wavelength range of the emitted laser beam. This may be used to obtain a denser depth map. FIG. 6b depicts a sensor array 600b, where the light filters 720b, 730b on top of the pixels may be arranged in a dense checkerboard pattern.

FIG. 6c shows another light filter arrangement. On top of the pixels of the sensor array 600c light filters which only transmit light at a specific wavelength may be arranged. The light filter 610c may only transmit visible light. The light filter 620c may only transmit light at the wavelength emitted by a first light source. The light filter 630c may only transmit light at the wavelength emitted by a second light source. This effectively solves the problem of assigning a triggered event due to projected light to a certain laser in hardware.

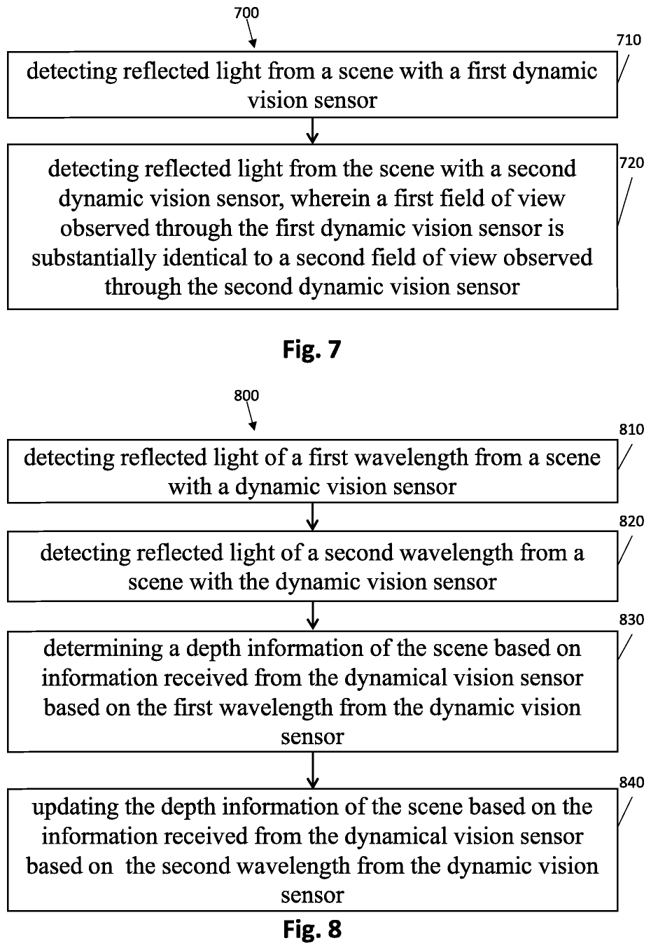

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIGS. 1-5) and/or below (e.g., FIGS. 7-8).

FIG. 7 shows a block diagram of an example of a method 700 for depth sensing. The method 700 comprises detecting 710 reflected light from a scene with a first dynamic vision sensor and detecting 720 reflected light from the scene with a second dynamic vision sensor. The first field of view observed through the first dynamic vision sensor is substantially identical to a second field of view observed through the second dynamic vision sensor. For performing the method 700 an arrangement for depth sensing as described with reference to FIG. 1 may be used.

In an example, the first dynamic vision sensor may be configured to detect light at a first wavelength and the second dynamic vision sensor may be configured to detect light at a second wavelength different from the first wavelength.

In an example, the method 700 may further comprise determining a depth information of the scene based on received information based on the first wavelength from the first dynamic vision sensor and updating the depth information of the scene based on the received information based on the second wavelength from the second dynamic vision sensor.

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIGS. 1-6) and/or below (e.g., FIG. 8).

FIG. 8 shows a block diagram of another example of a method 800 for depth sensing. The method 800 comprises detecting 810 reflected light of a first wavelength from a scene with a dynamic vision sensor and detecting 820 reflected light of a second wavelength from a scene with the dynamic vision sensor. Further, the method 800 comprises determining 830 a depth information of the scene based on information received from the dynamical vision sensor based on the first wavelength from the dynamic vision sensor and updating 840 the depth information of the scene based on the information received from the dynamical vision sensor based on the second wavelength from the dynamic vision sensor. For performing the method 800 an arrangement for depth sensing as described with reference to FIG. 3 may be used.

More details and aspects are mentioned in connection with the examples described above. The example shown in FIG. 8 may comprise one or more optional additional features corresponding to one or more aspects mentioned in connection with the proposed concept or one or more examples described above (e.g., FIGS. 1-7).

The following examples pertain to further embodiments:
(1) An arrangement for depth sensing, comprising a first dynamic vision sensor and a second dynamic vision sensor. Further, the arrangement comprises a beam splitter arranged in an optical path between a scene and the first dynamic vision sensor and the second dynamic vision sensor. The second dynamic vision sensor is calibrated with respect to the first dynamic vision sensor, such that a first field of view observed through the first dynamic vision sensor is substantially identical to a second field of view observed through the second dynamic vision sensor.
(2) The arrangement of (1), wherein the first dynamic vision sensor is configured to detect a change in luminance in a photo-current of the scene at a first wavelength and the second dynamic vision sensor is configured to detect a change in luminance in a photo-current of the scene at a second wavelength different from the first wavelength.
(3) The arrangement of any one of (1) to (2) further comprising a first lens corresponding to the first dynamic vision sensor and a second lens corresponding to the second dynamic vision sensor, wherein the beam splitter is arranged in an optical path between the scene and the first lens and the second lens.
(4) The arrangement of any one of (1) to (3), wherein the beam splitter substantially transmits 50% of the light along the optical path and substantially reflects 50% of the light along the optical path.
(5) The arrangement of any one of (2) to (4), further comprising a light source to emit light onto the scene comprising the first wavelength.
(6) The arrangement of (5) further comprising an optical diffraction grating to generate a light pattern that is cast onto the scene and reflected by the scene towards the beam splitter.
(7) The arrangement of (6) further comprising a scanning mirror that can be used to change an illuminance of the light pattern onto the scene.
(8) The arrangement of (7) further comprising processing circuitry communicatively coupled to the scanning mirror, the first dynamic vision sensor and the second dynamic vision sensor and configured to control an orientation of the scanning mirror and receive information from the first dynamic vision sensor and the second dynamic vision sensor.
(9) The arrangement of (8) wherein the processing circuitry is further configured to read events of at least one of the first dynamic vision sensor or the second dynamic vision sensor for time synchronization between an orientation of the scanning mirror and at least one of the first dynamic vision sensor or the second dynamic vision sensor.
(10) The arrangement of any one of (7) to (9) wherein the processing circuitry is further configured to determine a depth information of the scene based on first information received from the first dynamic vision sensor.
(11) The arrangement of (10) wherein the processing circuitry is further configured to update the depth information of the scene based on second information received from the second dynamic vision sensor.
(12) The arrangement of any one of (7) to (8) further comprising an inertial measurement unit communicatively coupled to the processing circuitry configured to determine at least one of information about a movement of the scene or information about a movement of the arrangement and detect a dynamic object in the scene based on the determined information about at least one of a movement of the scene or a movement of the arrangement.
(13) The arrangement of any one of (5) to (12) further comprising a further light source to emit light onto the scene.
(14) The arrangement of (13) wherein the light emitted by the further light sources comprises the first wavelength or the second wavelength.
(15) A device, comprising a light source to emit light onto a scene comprising a first wavelength and a dynamic vision sensor comprising a plurality of light filters. A first light filter of the plurality of light filters transmits the first wavelength and a second light filter of the plurality of light filters transmits a second wavelength different from the first wavelength. Further, the device comprises processing circuitry communicatively coupled to the dynamic vision sensor and configured to determine a depth information of the scene based on information received from the dynamical vision sensor based on the first wavelength and update the depth information of the scene based on the information received from the dynamical vision sensor based on the second wavelength.
(16) The device of (15) further comprising an optical diffraction grating to generate a light pattern that is cast onto the scene and reflected by the scene towards the DVS.
(17) The device of any one of (15) to (16) further comprising a scanning mirror that can be used to change an illuminance of the light pattern onto the scene.
(18) The device of any one of (15) to (17), wherein the processing circuitry is further communicatively coupled to the scanning mirror. Further, the processing circuitry may be configured to control an orientation of the scanning mirror.
(19) The device of (18), wherein the processing circuitry is further configured to read events of the dynamic vision sensor for time synchronization between an orientation of the scanning mirror and the dynamic vision sensor.
(20) The device of any one of (15) to (19), wherein the processing circuitry is further configured to determine a depth information of the scene based on information received from the dynamic vision sensor based on the first wavelength.
(21) The device of any one of (15) to (20), wherein the processing circuitry 280 is further configured to update the depth information of the scene based on information received from the dynamic vision sensor based on the second wavelength.

(22) The device of any one of (15) to (21) further comprising an inertial measurement unit (IMU) communicatively coupled to the processing circuitry. The IMU is configured to determine at least one of information about a movement of the scene or information about a movement of the arrangement and to detect a dynamic object in the scene based on the determined information about at least one of a movement of the scene or a movement of the arrangement.
(23) The device of any one of (15) to (22) further comprising a further light source to emit light onto the scene.
(24) The device of any one of (15) to (23), wherein the light emitted by the further light sources may comprise the first wavelength or the second wavelength.
(25) A method comprising detecting reflected light from a scene with a first dynamic vision sensor and detecting reflected light from the scene with a second dynamic vision sensor. A first field of view observed through the first dynamic vision sensor is substantially identical to a second field of view observed through the second dynamic vision sensor.
(26) The method of (25), wherein the first dynamic vision sensor is configured to detect light at a first wavelength and the second dynamic vision sensor is configured to detect light at a second wavelength different from the first wavelength.
(27) The method of (26), further comprising determining a depth information of the scene based on received information based on the first wavelength from the first dynamic vision sensor and updating the depth information of the scene based on the received information based on the second wavelength from the second dynamic vision sensor.
(28) A method, comprising detecting reflected light of a first wavelength from a scene with a dynamic vision sensor and detecting reflected light of a second wavelength from a scene with the dynamic vision sensor. Further, the method comprises determining a depth information of the scene based on information received from the dynamical vision sensor based on the first wavelength from the dynamic vision sensor and updating the depth information of the scene based on the information received from the dynamical vision sensor based on the second wavelength from the dynamic vision sensor.
(29) A computer program having a program code for performing the method of any one of (25) to (28), when the computer program is executed on a computer, a processor, or a programmable hardware component.
(30) A non-transitory machine-readable medium having stored thereon a program having a program code for performing the method of any one of (25) to (28), when the program is executed on a processor or a programmable hardware.
(31) An arrangement for depth sensing, comprising a dynamic vision sensor arrangement, wherein the dynamic vision sensor arrangement is configured to detect a change in lumi- nance in a photo-current of a scene at a first wavelength and at a second wavelength different from the first wavelength.
(32) The arrangement of (31), wherein the dynamic vision arrangement comprises a first dynamic vision sensor configured to detect the change in luminance in a photo-current of the scene at the first wavelength and a second dynamic vision sensor configured to detect the change in luminance in the photo-current of the scene at the second wavelength different from the first wavelength.
(33) The arrangement of (32), wherein the dynamic vision arrangement comprises a beam splitter arranged in an optical path between a scene and the first dynamic vision sensor and the second dynamic vision sensor, wherein the second dynamic vision sensor is calibrated with respect to the first dynamic vision sensor, such that a first field of view observed through the first dynamic vision sensor is substantially identical to a second field of view observed through the second dynamic vision sensor.
(34) The arrangement of (31), wherein the dynamic vision arrangement comprises a dynamic vision sensor comprising a plurality of light filters, wherein a first light filter of the plurality of light filters transmits the first wavelength and a second light filter of the plurality of light filters transmits a second wavelength different from the first wavelength.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The processing circuitry described above may be a computer, processor, control unit, (field) programmable logic array ((F) PLA), (field) programmable gate array ((F) PGA), graphics processor unit (GPU), application-specific integrated circuit (ASICs), integrated circuits (IC) or system-on-a-chip (SoCs) system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An arrangement for depth sensing, comprising:
a first dynamic vision sensor;
a second dynamic vision sensor; and
a beam splitter arranged in an optical path between a scene and the first dynamic vision sensor and the second dynamic vision sensor, wherein
the second dynamic vision sensor is calibrated with respect to the first dynamic vision sensor, such that a first field of view observed through the first dynamic vision sensor is substantially identical to a second field of view observed through the second dynamic vision sensor.

2. The arrangement according to claim 1, wherein
the first dynamic vision sensor is configured to detect a change in luminance in a photo-current of the scene at a first wavelength and
the second dynamic vision sensor is configured to detect a change in luminance in a photo-current of the scene at a second wavelength different from the first wavelength.

3. The arrangement according to claim 1, further comprising:
a first lens corresponding to the first dynamic vision sensor; and
a second lens corresponding to the second dynamic vision sensor, wherein
the beam splitter is arranged in an optical path between the scene and the first lens and the second lens.

4. The arrangement according to claim 1, wherein the beam splitter substantially transmits 50% of the light along the optical path and substantially reflects 50% of the light along the optical path.

5. The arrangement according to claim 2, further comprising
a light source to emit light onto the scene comprising the first wavelength.

6. The arrangement according to claim 5, further comprising
an optical diffraction grating to generate a light pattern that is cast onto the scene and reflected by the scene towards the beam splitter.

7. The arrangement according to claim 6, further comprising
a scanning mirror that can be used to change an illuminance of the light pattern onto the scene.

8. The arrangement according to claim 7, further comprising
processing circuitry communicatively coupled to the scanning mirror, the first dynamic vision sensor and the second dynamic vision sensor and configured to:
control an orientation of the scanning mirror; and
receive information from the first dynamic vision sensor and the second dynamic vision sensor.

9. The arrangement according to claim 8, wherein
the processing circuitry is further configured to read events of at least one of the first dynamic vision sensor or the second dynamic vision sensor for time synchronization between an orientation of the scanning mirror and at least one of the first dynamic vision sensor or the second dynamic vision sensor.

10. The arrangement according to claim 7, wherein
the processing circuitry is further configured to determine a depth information of the scene based on first information received from the first dynamic vision sensor.

11. The arrangement of claim 10, wherein
the processing circuitry is further configured to update the depth information of the scene based on second information received from the second dynamic vision sensor.

12. The arrangement according to claim 7, further comprising
an inertial measurement unit communicatively coupled to the processing circuitry configured to:
determine at least one of information about a movement of the scene or information about a movement of the arrangement; and
detect a dynamic object in the scene based on the determined information about at least one of a movement of the scene or a movement of the arrangement.

13. The arrangement according to claim 5, further comprising
a further light source to emit light onto the scene.

14. The arrangement according to claim 13, wherein
the light emitted by the further light sources comprises the first wavelength or the second wavelength.

15. A device, comprising:
a light source to emit light onto a scene comprising a first wavelength;
a dynamic vision sensor comprising a plurality of light filters, wherein a first light filter of the plurality of light filters transmits the first wavelength and a second light filter of the plurality of light filters transmits a second wavelength different from the first wavelength; and
processing circuitry communicatively coupled to the dynamic vision sensor and configured to:
determine a depth information of the scene based on information received from the dynamical vision sensor based on the first wavelength; and
update the depth information of the scene based on the information received from the dynamical vision sensor based on the second wavelength.

16. A method, comprising:
detecting reflected light from a scene with a first dynamic vision sensor; and
detecting reflected light from the scene with a second dynamic vision sensor, wherein a first field of view observed through the first dynamic vision sensor is substantially identical to a second field of view observed through the second dynamic vision sensor.

17. The method according to claim 16, wherein
the first dynamic vision sensor is configured to detect light at a first wavelength and the second dynamic vision sensor is configured to detect light at a second wavelength different from the first wavelength.

18. The method according to claim 17, further comprising:
determining a depth information of the scene based on received information based on the first wavelength from the first dynamic vision sensor; and
updating the depth information of the scene based on the received information based on the second wavelength from the second dynamic vision sensor.

19. A method, comprising:
detecting reflected light of a first wavelength from a scene with a dynamic vision sensor;
detecting reflected light of a second wavelength from a scene with the dynamic vision sensor;
determining a depth information of the scene based on information received from the dynamical vision sensor based on the first wavelength from the dynamic vision sensor; and
updating the depth information of the scene based on the information received from the dynamical vision sensor based on the second wavelength from the dynamic vision sensor.

20. A computer program having a program code for performing the method according to any of claim 16 or 19, when the computer program is executed on a computer, a processor, or a programmable hardware component.
